(19) United States
(12) Patent Application Publication
(10) Pub. No.: US 2022/0067423 A1
(43) Pub. Date: Mar. 3, 2022

(54) METHOD AND SYSTEM FOR PROVIDING AND APPLYING A UNIFIED DECODING EFFICIENCY SCORE WITH FOCUS ON ENVIRONMENTAL IMPACT

(71) Applicant: Beijing DiDi Infinity Technology and Development Co., Ltd., Beijing (CN)

(72) Inventors: Amittai AXELROD, Los Angeles, CA (US); Scot FANG, Los Angeles, CA (US); Kevin KNIGHT, Los Angeles, CA (US)

(21) Appl. No.: 17/003,700

(22) Filed: Aug. 26, 2020

(51) Int. Cl. G06K 9/62; G06N 20/00; G06F 40/58

(52) U.S. Cl. CPC G06K 9/623; G06K 9/6202; G06F 40/58; G06N 20/00; G06K 9/6215

(57) ABSTRACT

A method may comprise obtaining a machine-learning output generated by a computer system running a trained machine-learning model; obtaining characteristics associated with the generation of the output, the characteristics comprising at least one of an energy term or a power term; determining a precision term for the system based on a comparison of the output with a reference; and determining an overall score of the system based on the precision term and the characteristics.

### TECHNICAL FIELD

The disclosure relates generally to machine translation, natural language processing, machine learning, and methods for evaluating and optimizing such systems.

### BACKGROUND

Environmental footprint reduction is an increasing focus in business operations and in individuals' daily lives. Today, many companies strive to achieve some level of Leadership in Energy and Environmental Design (LEED) certification, or other certification, acknowledging a minimal net impact on the environment. Reducing environmental impact is desirable, especially fighting and mitigating climate change. Increasing energy and power efficiency is one important way of reducing environmental impact.

The consumption of electricity, energy, and power may have a significant impact on the environment, especially in larger-scale operations. When tasks are performed frequently or on large amounts of data, the difference in overall electricity, energy, or power consumption for even a slightly more energy-efficient system may be substantial. Reducing the amount of electricity, energy, or power consumed by a task may reduce the amount of heat directly produced by the system (and by the associated fan or cooling unit) in using the electricity, the amount of heat produced in generating or transmitting the electricity, and the amount of greenhouse emissions produced during electricity generation. Additionally, there may be reasons to reduce the energy or power used by a system other than environmental concerns: electricity costs money, and the less electricity that is required to perform the same tasks, the less expensive those operations become. This cost savings, in switching to a more energy-efficient system, could be converted to increased profits, lower prices, and/or increased output of generated information for the same cost.

Machine learning (ML), natural-language processing (NLP), and machine translation (MT) systems can use large amounts of energy. The energy-reduction endeavor is particularly applicable to these three types of systems based on the amount of computation they may use, and the tendency to increase the amount of computation even where there may be minimal increases to performance. There currently is no system or method that explicitly accounts for the trade-offs between increased performance and decreased energy or power efficiency for evaluating these three system types.

Therefore, there exists a need for a system and method for (1) evaluating ML, NLP, and MT systems based on power and/or energy; (2) selecting an ML, NLP, or MT system based on power and/or energy; and (3) optimizing ML, NLP, and MT systems based on power and/or energy.

### SUMMARY

Various embodiments of the specification include, but are not limited to, systems, methods, and non-transitory computer readable media for providing and applying a unified decoding efficiency score with focus on environmental impact.

One aspect of the specification is a method. In various implementations, a method may include obtaining a machine-learning output generated by a computer system running a trained model; obtaining characteristics associated with the generation of the output, the characteristics comprising at least one of an energy term or a power term; determining a precision term for the system based on a comparison of the output with a template; and determining an overall score of the system based on the precision term, the characteristics, and the plurality of baseline terms.

In some embodiments, the machine-learning output may comprise a machine translation of the input.

In some embodiments, the precision term may comprise a BLEU score.

In some embodiments, the computer system may comprise a natural-language-processing algorithm and/or model.

In some embodiments, the characteristics may comprise an energy term, or a power term, or both.

In some embodiments, the precision term may be a BLEU score; the energy term may be a decoding energy efficiency that is based on a measured energy consumption and the BLEU score; and the power term may be a decoding power efficiency that is based on a measured power consumption and the BLEU score.

In some embodiments, the system may comprise a CPU, a GPU, and an algorithm written in a software language; and the method may further include changing at least one of the CPU, the GPU, or the software language, and repeating the steps of obtaining the machine-learning output, obtaining the characteristics, determining the precision term, and determining the overall score.

In some embodiments, the system may comprise a model that has one or more hidden layers; and the method may further comprise: iteratively changing the number of hidden layers in the model, repeating, for each iteration, the steps of obtaining the machine-learning output, obtaining the characteristics, determining the precision, and determining the overall score, comparing each subsequent iteration of the overall score with at least one prior iteration of the overall score, and determining an optimal number of hidden layers for the model based on the comparison of the overall scores.

In some embodiments, the determining the overall score may comprise: scaling the precision term based on a baseline precision term; if the characteristics comprise an energy term, scaling the energy term based on a baseline energy term; and if the characteristics comprise a power term, scaling the power term based on the baseline power term.

In some embodiments, the precision term may comprise a BLEU score; the power term may comprise the inverse of the power consumed by the system to generate the output; the energy term may comprise the inverse of the energy consumed by the system to generate the output; and the terms may each be scaled by a different factor.

In some embodiments, determining the overall score further comprises taking a square root of a sum of squares of the scaled terms.

Another aspect of the specification is a system. In various implementations, a system may include: one or more processors; and a memory storing instructions that, when executed by the one or more processors, cause the system to perform: obtaining a machine-learning output generated by a computer system running a trained model; obtaining characteristics associated with the generation of the output, the characteristics comprising at least one of an energy term or a power term; determining a precision term for the system based on a comparison of the output with a template; and determining an overall score of the system based on the precision term and the characteristics.

In some embodiments, the instructions further cause the one or more processors to perform: determining that the system is inferior; and displaying on a monitor, based on the determined inferiority, a notification indicating that the system should not be deployed.

Another aspect of the specification is a method of determining which machine translation system to deploy. In various implementations, a method of determining which machine translation (MT) system to deploy may include: obtaining a first MT output, the first MT output having been generated by a first MT system; obtaining a second MT output, the second MT output having been generated by a second MT system; obtaining an MT template, the MT template comprising a reference translation; obtaining first characteristics associated with the generation of the first MT output, the first characteristics comprising at least one of energy or power or their efficiencies; obtaining second characteristics associated with the generation of the second MT output, the second characteristics comprising at least one of energy or power or their efficiencies; determining a precision of the first MT system based on a comparison of the first MT output and the MT template; determining a precision of the second MT system based on a comparison of the second MT output and the MT template; determining an overall score for the first MT system based on the precision of the first MT system and the first characteristics; determining an overall score for the second MT system based on the precision of the second MT system and the second characteristics; comparing the overall score for the first MT system and the overall score for the second MT system; and determining, based on the comparison of the overall scores, that the first MT system be implemented.

In some embodiments, the method may further comprise deploying the first MT system, in lieu of the second MT system.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention. It is to be understood that the foregoing general description and the following detailed description are exemplary and explanatory only, and are not restrictive of the invention, as claimed.

### BRIEF DESCRIPTION OF THE DRAWINGS

Preferred and non-limiting embodiments of the invention may be more readily understood by referring to the accompanying drawings in which:

FIG. 1 illustrates an exemplary system to which techniques for evaluating and selecting an ML, NLP, or MT system may be applied, in accordance with various embodiments.

FIG. 2 illustrates a flowchart of an exemplary method, according to various embodiments of the specification.

FIG. 3 illustrates a flowchart of an exemplary method, according to various embodiments of the specification.

FIG. 4 illustrates a flowchart of an exemplary method, according to various embodiments of the specification.

FIG. 5 illustrates a flowchart of an exemplary method, according to various embodiments of the specification.

FIG. 6 is a block diagram that illustrates a computer system upon which any of the embodiments described herein may be implemented.

### DETAILED DESCRIPTION OF THE EMBODIMENTS

Specific, non-limiting embodiments of the present invention will now be described with reference to the drawings. It should be understood that particular features and aspects of any embodiment disclosed herein may be used and/or combined with particular features and aspects of any other embodiment disclosed herein. It should also be understood that such embodiments are by way of example and are merely illustrative of a small number of embodiments within the scope of the present invention. Various changes and modifications obvious to one skilled in the art to which the present invention pertains are deemed to be within the spirit, scope and contemplation of the present invention as further defined in the appended claims.

ML, NLP, and MT systems are being developed by a number of organizations, and the systems being created vary widely in the amount of energy (and electricity and power) required for training or running a task. Most organizations working to develop these systems focus on improving accuracy, which generally requires a larger training set and a more complicated and energy-intensive model. This approach, for increasing model size in order to improve accuracy, may have diminishing returns in terms of power and energy usage. The performance of these systems is evaluated with accuracy/precision scores that may be represented by metrics such as error-rates (typically for ML and some NLP applications) or BLEU score (for MT). These metrics only account for accuracy/precision—“error” may be the difference between predicted values and actual values, and BLEU scores may be a value representing the similarity between outputs and templates. In optimizing systems, or selecting which of several systems to implement, developers have been focusing on accuracy/precision alone. More recently, the size of the memory footprint has been used as a consideration. However, there exists a need to select and optimize systems based on more than accuracy, precision, and memory footprint, especially where slight increases in accuracy are coupled with drastic increases in energy consumption.

With an understanding of the need for more energy-efficient systems, and how current systems are being evaluated based on an accuracy/precision metric that does not account for energy/power consumption, it is advantageous to have a basic understanding of these systems. ML is applied to perform a variety of tasks, including recognizing patterns and making predictions. NLP is applied to process and analyze natural language data, such as predicting the answer to a question presented by a user. MT is an NLP subtask, applied to translate content from a first language to a second language, such as generating a document in English from a document composed in German. ML, NLP, and MT may be separate categories of algorithms (or models) and systems, or may be overlapping. For the ease of description, a term “trained machine learning model” is used to refer to a machine-learning based classifier, a MT system, an NLP system, and/or another suitable machine learning model that has been trained.

Some machine learning models (e.g., MT and NLP) may be evaluated based on a BLEU score. A BLEU score is a precision term generally described as an averaged percentage of n-gram matches. A “(uni)gram” is typically a single word, where an “n-gram” is a set of a number (n) of words. For example, for a MT system, determining a BLEU score may involve comparing a number of terms, consisting of a number of words (ranging from one to n), that are the same (or similar) between an output translation of the MT system and a template translation. For example, if n is three, then (in some implementations) the system may determine the number of individual words that are the same, the number of two-word terms that are the same, and the number of three-word terms that are the same; then, the system may come up with a corresponding percentage, and this percentage would be the basis for the BLEU score. There are many variations in how a BLEU score may be determined. One major factor is the size of the variable “n.” Other factors include weights assigned to each gram-level (e.g., number of words in a term), and how similar or identical the terms must be (e.g., whether there is case-sensitivity). However, the function of a BLEU score is to determine precision and accuracy (sometimes referred to as “precision” alone).

In some embodiments, a template translation may be referred to as a reference translation (the terms “template” and “reference” may be used interchangeably). The term template (i.e., reference) may refer to something that is used for comparison. In some embodiments, a template (i.e., reference) may be a desired output. In some embodiments, the term “algorithm” may refer to a “model” and/or a “neural network,” depending on context. In some embodiments, implementing an algorithm, system, and/or model may refer to deploying the algorithm, system and/or model.

A precision may be a measure of how close the system output is to a desired result. In some embodiments, a precision may be a measure of a performance of a system that does not directly account for power or energy characteristics, quantity of memory consumed, or speed of a system. In some embodiments, precision of ML and NLP applications may be defined by a percentage of correct terms. Precision may also be defined by an F-score, or other statistical metrics. An F-score may be useful in that it can involve distinguishing between true positives and false positives. F-scores may be especially practical in applications like detection (e.g., determining if an object is present in an image), document classification, and information retrieval. In some embodiments, a precision may include a number of true positive results over a number of total samples. In some embodiments, a precision may be a number between zero and one.

The implementation of ML, NLP, and MT may include training models and deploying the trained models. Training the models may include providing samples to the system for pattern recognition and optimization. Deploying the models may include using a trained model to determine solutions (provide outputs) to solve actual problems (such as providing a translation, or answering a query). Deployment may include application of the MT system by an end-user.

Both of these stages of implementation (training and deployment) have different amounts of associated power consumption and overall energy consumption, and have different characteristics. From a lifetime-view of the system, deployment will typically require drastically more energy—based on the quantity and size of tasks being performed over an extended period of time—than the training stage. Most of the development of ML, NLP, and MT systems is focused on the training stage of implementation, rather than on the deployment stage, which may be a sub-optimal approach. Therefore, targeting the assessment of ML, NLP, and MT systems on the deployment stage of use, rather than on the training stage, may result in systems with lower lifetime power and/or energy consumption being deemed better than systems that are merely more power and/or energy efficient to train.

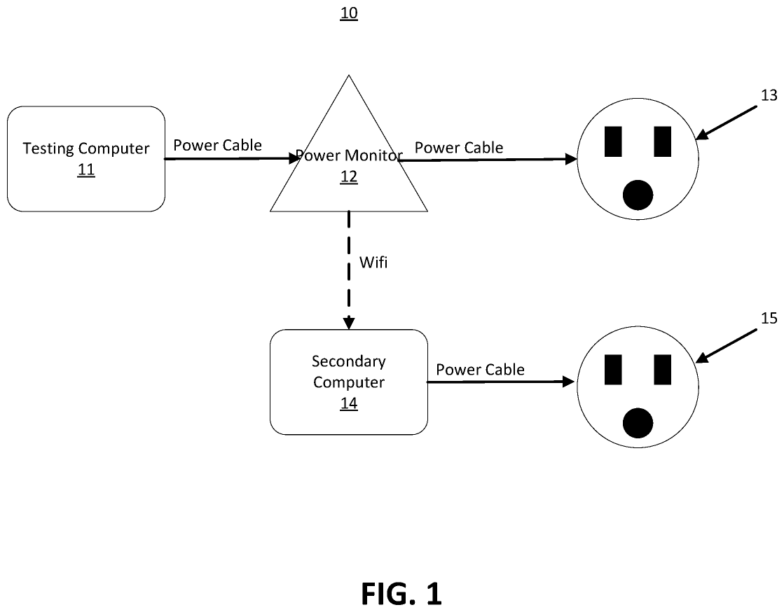

FIG. 1 illustrates an exemplary system 10 to which techniques for evaluating and selecting an ML, NLP, or MT system may be applied, in accordance with various embodiments. The example system 10 may include a testing computer 11, a power monitor 12, a first outlet 13, a secondary computer 14, and a second outlet 15. It is to be understood that although two computers are shown in FIG. 1, any number of computing devices may be included in the system 10. It is noted that in some embodiments, the exemplary system 10 may comprise fewer, more, or alternative components.

The testing computer 11 may comprise hardware and/or software. In some embodiments, the testing computer 11 may comprise a laptop, desktop, tablet, smart phone, or other device comprising one or more processors and a memory. In some embodiments, the testing computer may comprise a CPU and/or a GPU. In some embodiments, the testing computer 11 may comprise a trained ML, NLP, and/or MT algorithm, and may run that algorithm (or model) on an input to provide an output. In some embodiments, the testing computer 11 may receive an input, such as a text document written in German. In some embodiments, the testing computer 11 may, upon beginning and terminating a computation, provide a signal to the power monitor 12 so that the power monitor will record and/or transmit associated power and/or energy information. In some embodiments, the power monitor 12 or secondary computer 14 may determine when to begin and end recording power and/or energy information. In some embodiments, the testing computer 11 may send the output file to the secondary computer 14 so that the secondary computer 14 can determine a precision. In some embodiments, the testing computer 11, after ending a computation, may itself compare the output to a template to determine a precision. In some embodiments, the testing computer 11 applies a trained model that is in the deployment and/or testing stage of implementation (in contrast to the training stage).

The secondary computer 14 may be connected to the power monitor 12 to receive characteristics such as a power term and/or an energy term. As illustrated, the secondary computer 14 is connected to the power monitor 12 over WIFI. In some embodiments, the secondary computer may be connected to the power monitor 12 through Bluetooth, a physical cable, etc. The power monitor 12 may receive power and/or energy information between the first outlet 13 and the testing computer 11, such as by measuring a current and/or voltage between the first outlet 13 and the testing computer 11. In some embodiments, the power monitor 12 may send power and/or energy information to the secondary computer 14 incrementally or continuously. In some embodiments, the power monitor 12 may calculate average power and/or total energy. In some embodiments, the secondary computer 14 may calculate average power and/or total energy. In some embodiments, the functions of the secondary computer 14, the power monitor 12, and the testing computer 11 may be performed on a single device. In some embodiments, one or more of the functions of the secondary computer 14 may be performed on the testing computer 11.

In some embodiments, the secondary computer 14 may compute a precision term (e.g., a BLEU score), a power term, and/or an energy term for the testing computer system 11. In some embodiments, the secondary computer 14 may compute an overall score. In some embodiments, the secondary computer 14 may determine overall scores for more than one testing computer; and may determine, based on those scores, that the testing computer 11 should be deployed in lieu of the one or more other computers. In some embodiments, the secondary computer 14 may display the overall score of the testing computer 11 on a display screen for a user to see; and/or may present a suggestion that the testing computer 11 be implemented. In some embodiments, a suggestion may comprise a notification that a system should not be deployed. In some embodiments, the secondary computer 14 may determine that an algorithm, model, hardware, or system (a combination of algorithm, model, and/or hardware) is inferior. In some embodiments, the secondary computer 14 may determine that a software framework (including toolkits and implementation language) and/or operating system is inferior. A determination of inferiority may be based on a comparison of overall scores.

In some embodiments, the secondary computer 14 connects to the power monitor 12 via a Wi-Fi connection. In some embodiments, the secondary computer 14 is connected to the second outlet 15. The secondary computer 14 may be implemented in one or more networks (e.g., enterprise networks), one or more endpoints, one or more servers, or one or more clouds. A server may include hardware or software that manages access to a centralized resource or service in a network. A cloud may include a cluster of servers and other devices which are distributed across a network.

In some embodiments, the first outlet 13 may be separate from the second outlet 15 for purposes of isolation of the power and/or energy measurements. In some embodiments, the second outlet 15 may not be necessary. In some embodiments, the first outlet 13 may be a power source such as a battery. In some embodiments, a power cable may be a wire or other way of connecting a power source to a CPU and/or GPU. One benefit of the exemplary system 10 may be that it may provide a method for accurately measuring the power and/or energy usage, as an alternative to estimating power and/or energy consumption.

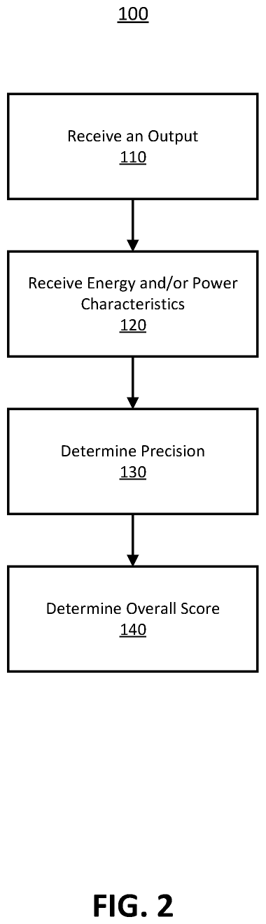

FIG. 2 illustrates a flowchart of an exemplary method 100, according to various embodiments of the specification. The method 100 may be implemented in various environments including, for example, on a computer. In some embodiments, the method 100 may be performed by the exemplary system 10. The operations of the method 100 presented below are intended to be illustrative. Depending on the implementation, the method 100 may include additional, fewer, or alternative steps performed in various orders or in parallel. The method 100 may be implemented in various computing systems or devices including one or more processors.

With respect to the method 100, at block 110, the method 100 may comprise receiving an output. In some embodiments, the block 110 may be performed by the secondary computer 14 of the exemplary system 10. For example, an output may be received by the secondary computer 14 from the testing computer 11. An output may be received by a computing system (such as one or more computers). Receiving an output may comprise receiving an output of an ML system, an output of an NLP system, and/or an output of an MT system. As an example, the received output may comprise a machine translation (e.g., a document with content in English that was generated based on a document with content in French).

At block 120, the method 100 may comprise receiving energy and/or power characteristics. In some embodiments, the block 120 may be performed by the secondary computer 14 of the exemplary system 10. For example, the secondary computer 14 may receive energy and/or power characteristics from the power monitor 12. In some embodiments, energy and power characteristics may be obtained between a power source (such as the first outlet 13) and a system (such as the testing computer 11). In some embodiments, energy and power characteristics may be obtained locally on a computer. In some embodiments, energy and power characteristics may be measured directly.

Energy characteristics may be based on the total amount of energy attributable to a computation process. In some embodiments, a computation process may be a portion of an overall process that is deemed to be distinct or important. In some embodiments, a computation process may be the entire process, from start to finish, of carrying out a function. For example, a computation process may be the entire process of generating a translation of a document, from the time the execution of the function is initiated to the time the execution of the function is ended. In some embodiments, energy characteristics may comprise the total energy attributable to a computation process. In some embodiments, energy characteristics may comprise the inverse of the total energy attributable to a computation process. In some embodiments, energy characteristics may comprise an energy efficiency. In some embodiments, an energy efficiency may comprise a precision term divided by a total amount of energy attributable to a computation process. In some embodiments, a precision term may comprise a BLEU score.

In some embodiments, power characteristics may comprise an average power, such as the average power consumed by a system during a computation process. The term “consumed” may be used interchangeably with the term “dissipated.” In some embodiments, power characteristics may comprise a peak power, such as a maximum power consumed by a system during a computation process. In some embodiments, power characteristics may comprise an average power consumption during a computation process. In some embodiments, power characteristics may comprise the inverse of an average power, or may comprise a power efficiency. A power efficiency may comprise a precision term divided by an average power attributable to a computation process.

At block 130, the method 100 may comprise determining a precision. In some embodiments, the block 130 may be performed by the secondary computer 14 of the exemplary system 10. For example, the secondary computer 14 may determine a precision of an output provided by the testing computer 11. A precision may represent how accurate a result is, when compared to a reference output (a solution assumed to be correct that is used for comparison). A reference output may be an output that is desired to be replicated. In some embodiments, determining a precision may comprise comparing an output to a template. In some embodiments, determining a precision may comprise determining an error rate, a number of FLOPS, an F-score, and/or a BLEU score. As an example, determining a precision may comprise comparing a machine translation to a template human translation to calculate a BLEU score.

At block 140, the method 100 may comprise determining an overall score. In some embodiments, the block 140 may be performed by the secondary computer 14 of the exemplary system 10. For example, the secondary computer 14 may compute an overall score based on the precision and the power and/or energy characteristics. An overall score may comprise a score that can be used to compare multiple systems. In some embodiments, an overall score may be determined by relating the energy characteristics (energy term), the power characteristics (power term), and/or the precision (precision term). An overall score may be referred to as a “unified decoding efficiency score.” The overall score may be unified based on both the precision of the system (whether it be ML, NLP, or MT, etc.) and the power and/or energy characteristics (the environmentally-focused aspect of the system). The overall score may be of decoding efficiency based on including a power efficiency or energy efficiency associated with decoding. As an example, for MT, decoding may be the conversion (or generation) of a document from one language to another; and for NLP, decoding may be the conversion (or generation) of a human (natural) language document into a form that is useful to a computer.

In some embodiments, comparing the energy, power, and/or precision terms may comprise normalizing the energy, power, and/or precision terms, such as by scaling the terms with one or more factors. In some embodiments, comparing the energy, power, and/or precision terms may comprise computing a norm, such as a Euclidean norm, of the energy, power, and/or precision terms. For example, the overall score may be determined using Equation (1).

$$Overall Value = \sqrt{{( α B )}^{2} + {( γ \frac{B}{P} )}^{2} + {( ɛ \frac{B}{E} )}^{2}} \qquad ( 1 )$$

In Equation (1), “α” is a factor for scaling the precision term; “B” is the precision term; “γ” is a factor for scaling the power term; “B/P” is the power term; “ε” is a factor for scaling the energy term; and “B/E” is the energy term. In Equation (1), the power term is a decoding power efficiency, where “P” is a power; and the energy term is a decoding energy efficiency, where “E” is an energy.

In some embodiments, one of the scaling factors (α, γ, and δ) may be set to zero, thereby removing the associated term from Equation (1). In some embodiments, the scaling factors may be selected based on a baseline. In some embodiments, a baseline may be a system or value that is intended to be beaten. In some embodiments, a baseline may be a system or value that is intended to be matched. For example, a baseline precision term may be 95 BLEU, based on industry expectations, so α may be set to 1/95 to normalize the precision term to the baseline. The same may be true for the power and energy terms.

In some embodiments, the scaling factors may be set to normalize each of the terms based on a comparison to human metrics (a human baseline). For example, a translation template may be created by a human translator (albeit slowly) at a precision of one hundred BLEU (there are no errors if the human translation is the baseline/template); may take three hundred seconds (five minutes), and may consume an average of twenty watts (and six thousand joules) during the process. In this scenario, the precision is one hundred BLEU, the power efficiency is five BLEU per watt, and the energy efficiency is one BLEU per sixty joules. To normalize a system to these metrics, α may be set to 1/100, γ may be set to ⅕, and ε may be set to 60. In this example, the overall score is a measure of how a ML, NLP, or MT system compares to a human performing the same task. Different scaling factors can be used for different implementations. In some embodiments, such as the example above, if the system is better than the baseline, the overall score will be larger than the baseline's. In the example above, the overall score takes into account power efficiency, energy efficiency, and precision. A higher overall score may be an improvement based on indicating a higher precision, a lower power, and/or a lower energy consumption.

It is to be noted that the scaling factors (α, γ, and δ) may also take into account other considerations, and the values or equations associated with these factors may be implementation-specific. For example, in some embodiments, energy efficiency and precision may be found to be more important than power efficiency. Accordingly, in that example, α and ε may be kept at 1/100 and 60, as in the prior example, and γ may be reduced such as to 1/50. Additionally, the example human-based values are merely provided as an example—it is noted that sometimes humans may actually burn 100 Watts or more while performing a translation (or other task), and may actually achieve a BLEU score of only 60-70 or less, even if the translation is correct, based on a substitution of similar words or change in syntax when their translations (or other types of outputs) are compared to translation references (or other types of templates) created by different humans.

Additionally, in some embodiments, one or two of the scaling factors (α, γ, and δ) may be more important in some ranges than in others. For example, in some embodiments, power efficiency may be very important until reduced to twenty watts, at which point timing constraints may become an equally important (or more important) factor. This is because power and time are inversely related ([W]=[J]/[s]), and it may sometimes be important to perform a task with speed. For situations such as this, step functions may be used, as is illustrated in Equation (2).

$$Overall Value = \{ \begin{matrix}\sqrt{{( α B )}^{2} + {( γ \frac{B}{P} )}^{2} + {( ɛ \frac{B}{E} )}^{2}} , P > 20 watts \\ \sqrt{{( α B )}^{2} + {( ɛ \frac{B}{E} )}^{2}} , P \leq 20 watts\end{matrix} \qquad ( 2 )$$

In both of the equations presented above, a higher overall score may illustrate a better system. In Equation (2), the power threshold was set to twenty watts: it is to be noted that a power threshold may be set at other values, depending on the implementation. Additionally, in some implementations, step functions may be dependent on ranges of precision, and/or on ranges of energy. Additionally, in Equation (2), the power term was removed when the power value exceeded a threshold; however, in some embodiments, instead of removing a term entirely, the corresponding scaling factor may merely be changed. For example, precision may be more important until it reaches a threshold, and then become less important: based on the first example of the scaling factor values, α may be 1/100 for B<=90 (e.g., a precision score is below 90%), then a may be 1/200 or may decrease accordingly for B>90 (i.e., precision becomes less important after reaching 90%).

In some embodiments, taking into account the power efficiency and/or energy efficiency associated with a task may be beneficial when selecting and/or optimizing systems—this may be especially true where the power, energy, and precision are determined during testing or deployment, rather than during training, since the actual use of the system during deployment will likely involve more total energy dissipation than is used in the training stage. Taking into account energy and power consumption with the methods described in this disclosure, when evaluating a system (including the software and/or hardware implemented), may result in deployment of systems that have marginally lower precision, with significantly lower energy and power consumption. It is important, when weighing the benefits of energy and power efficiencies against the disbenefits of lower precision, to be able to quantify that determination. Without quantification, line-drawing between systems may be difficult, impractical, and arbitrary.

Additionally, it is notable that performing the steps of the method 100 is too complicated to practically be performed without a computer. Accurately and precisely measuring power and/or energy consumption of a system associated with a task can only be performed by sensing devices that include electrical and/or mechanical components. Next, computing a precision term may be very intensive, alone; but relating a precision term, a power term, and/or an energy term may be even more challenging and time-consuming. For large tasks, such as translating a book, no amount of time may be sufficient for a human to accurately determine a precision term without a computer. Applying one or more step functions, or determining a Euclidean norm, does not simplify this process. Quantitatively comparing two ML, NLP, or MT systems, based on a precision term and a power and/or energy term, cannot practically be performed without a computing system.

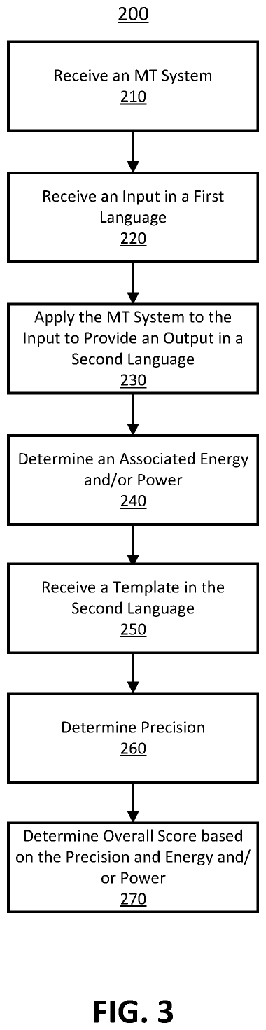

FIG. 3 illustrates a flowchart of an exemplary method 200, according to various embodiments of the specification. The method 200 may be implemented in various environments including, for example, on a computer. In some embodiments, the method 200 may be performed by the exemplary system 10. The operations of the method 200 presented below are intended to be illustrative. Depending on the implementation, the method 200 may include additional, fewer, or alternative steps performed in various orders or in parallel. The method 200 may be implemented in various computing systems or devices including one or more processors.

With respect to the method 200, at block 210, the method 200 may comprise receiving an MT system. In some embodiments, the block 210 may be performed by the secondary computer 14 of the exemplary system 10. For example, the secondary computer 14 may receive the testing computer 11, or may receive other hardware and software combinations, based on a wired or wireless connection. An MT system may comprise hardware and/or software. In some embodiments, an MT system may comprise computer components such as a GPU, a CPU, a motherboard, a PSU, a memory, a CPU, an HDD, and/or an SSD. In some embodiments, an MT system may comprise an MT model written in a software language, such as in JavaScript, Python, Java, C, C++, Objective-C, C#, Swift, Ruby, and/or SQL. In some embodiments, changes in the one or more computer components, and/or changes in the one or more software components and/or languages, may improve energy and/or power aspects of deploying particular systems.

At block 220, the method 200 may comprise receiving an input in a first language. In some embodiments, the block 220 may be performed by the testing computer 11 of the exemplary system 10. For example, the testing computer 11 may receive a German-language document, and may later perform the task of translating that document into English. Receiving an input in a first language may comprise receiving content in English, German, French, Chinese, or some other language. Receiving an input in a first language may comprise receiving a document, such as a Word document, a text document, or a PDF document.

At block 230, the method 200 may comprise applying the MT system to the input to provide an output in a second language. In some embodiments, the block 230 may be performed by the secondary computer 14 of the exemplary system 10. For example, the secondary computer 14 can cause the testing computer 11 to translate a document that has been received by the testing computer 11. However, in some embodiments, the testing computer 11 may translate an input without having to be prompted by the secondary computer 14. Applying the MT system to the input to provide an output in a second language may comprise running an MT algorithm (e.g., an MT model) on a computer to translate the document from the first language to the second language. For example, a document containing content in German may be received in block 220; and then, in block 230, an algorithm may be executed on a computer to analyze the German document, and to create a document in English based on the analysis of the German document.

At block 240, the method 200 may comprise determining an associated energy and/or power. In some embodiments, the block 240 may be performed by the secondary computer 14 of the exemplary system 10. For example, the secondary computer 14 may receive power and/or energy information from the power monitor 12; and convert the power and/or energy information into a power term and/or an energy term. For example, the secondary computer 14 may computer a power efficiency and/or energy efficiency. In some embodiments, the block 240 may be performed by the power monitor 12. For example, the power monitor 12 may obtain the power and/or energy consumption of the testing computer 11, while the testing computer 11 is translating a received document, by measuring the power flowing to the testing computer 11 from the first outlet 13.

In some embodiments, determining an associated energy and/or power may comprise receiving energy and/or power characteristics as in block 120 of the method 100. In some embodiments, determining an associated energy and/or power may refer to measuring power and/or energy usage directly (such as with an ammeter or voltmeter), receiving pre-measured energy and/or power usage data, computing energy and/or power characteristics (e.g., computing a total energy and/or an average power), receiving energy and/or power data that has already been computed, another suitable method for determining the associated energy and/or power, or any combination thereof.

In some embodiments, energy and/or power may be inferred based on a measured characteristic and a scale factor. For example, it may be beneficial to determine which algorithm (or model) to run on a cloud, whether to use a cloud service provider instead of a local computing system, or which cloud service provider to use, based on the environmental impact (e.g., the energy and/or power usage) of the entire system. However, accessing the actual hardware of the cloud system running the ML, NLP, or MT system might not be plausible. In such a situation, the actual energy and power usage may need to be estimated, and a fudge or scaling factor may need to be applied. A scaling factor may account for just the other hardware components of the system, or it can also take into account the overall energy efficiency of the data center where the machine is physically located, and/or the cost of supplying electricity to the location. For example, a fudge factor may be as high as 1.58, or may (with more precision) be reduced to 1.33 or even to 1.28. This means that after determining the GPU and CPU power and energy characteristics, the energy and power of the entire system may be approximated by multiplying the GPU and CPU power by 1.33 or 1.28, depending on how liberal of an estimate is desired for the application. Other measurable factors may be used to approximate actual power usage of a cloud or other system that is not entirely physically accessible, depending on the implementation.

Despite the ability to use other characteristics as proxies for power and energy values, in some embodiments, it may be more advantageous to use actual measured values in determining power and energy characteristics. For example, using proxies may lack the precision necessary in some implementations, and there may not be sufficient proxies available for evaluation.

At block 250, the method 200 may comprise receiving a template in the second language. In some embodiments, the block 250 may be performed by the secondary computer 14 of the exemplary system 10. For example, the secondary computer 14 may obtain a template from a memory, from another computer, and/or over the internet. A template in a second language may be a baseline that is deemed to be accurate for purposes of comparison with an output. A template may comprise content that has been validated by a human, such as by being drafted by a human or by being reviewed by a human. In some embodiments, a template may be created by one or more human translators. For example, a template may comprise an English version of the input, and the input may have been a German document.

At block 260, the method 200 may comprise determining a precision. In some embodiments, the block 260 may be performed by the secondary computer 14 of the exemplary system 10. In some embodiments, this step may comprise the any of the steps described for block 130 of the method 100. Determining a precision may comprise comparing the template to the output. A precision may indicate how close a system's output is to a goal, such as how similar or different an output is from a template. In some embodiments, determining a precision may comprise computing a BLEU score, F-score, and/or an error rate.

At block 270, the method 200 may comprise determining an overall score based on the precision and the energy and/or power. In some embodiments, the block 270 may be performed by the secondary computer 14 and/or power monitor 12 of the exemplary system 10. Determining an overall score may comprise relating the precision, and energy and/or power terms. In some embodiments, determining an overall score may comprise any of the features of determining the overall score in block 140 of the method 100.

In some embodiments, the method 200 may be an iterative process. For example, the method 200 may comprise an algorithm or model with hidden layers (such as a neural network); iteratively changing the number of hidden layers in the algorithm or model; and, for each iteration, repeating the steps of blocks 230, 240, 260, and 270. Further, in some embodiments, the method 200 may comprise comparing two or more iterations and/or systems. For example, if an iterative process is implemented, with the number of hidden layers (or the width of the hidden layers, e.g., 256/512/1024) changing in each iteration, the overall score in each iteration may be compared to the overall score of at least one prior iteration; and, based on the comparison, the number (or width) of hidden layers corresponding to the iteration with the best overall score may be determined to be optimal. In some embodiments, an optimal number of hidden layers, if determined, may be selected to be implemented (e.g., used for deployment and/or used by end-users) in lieu of systems with a different number of hidden layers. Iterative determinations of overall scores of systems with varying attributes, as in the prior example, may permit for an optimal system to be selected.

An iterative process may additionally or alternatively be applied to selection of hardware components such as CPU, GPU, and/or memory. Comparison of systems may also be beneficial when determining an optimal software language (such as C, C++, Java, etc.). For example, the secondary computer 14 of the exemplary system 10 may determine an overall score of the testing computer 11; change the CPU, GPU, software algorithm, and/or software language of the testing computer 11 (thereby repeating the block 210); apply the modified testing computer to the same input as before to provide a new output in the second language (thereby repeating block 230); determine an energy and/or power associated with the repeated block 230 (thereby repeating block 240); determine a precision of the new output (thereby repeating block 260); determine an overall score of the modified testing computer (thereby repeating block 270); then compare the overall score of the testing computer 11 with the modified testing computer to assess which MT system (of the two) is best (e.g., most suited for a particular application). An MT system may be determined to be best, for example, by having a higher overall score, given the scaling factors implemented in calculating the overall score. In some embodiments, the method may also comprise deploying the MT system determined to be best.

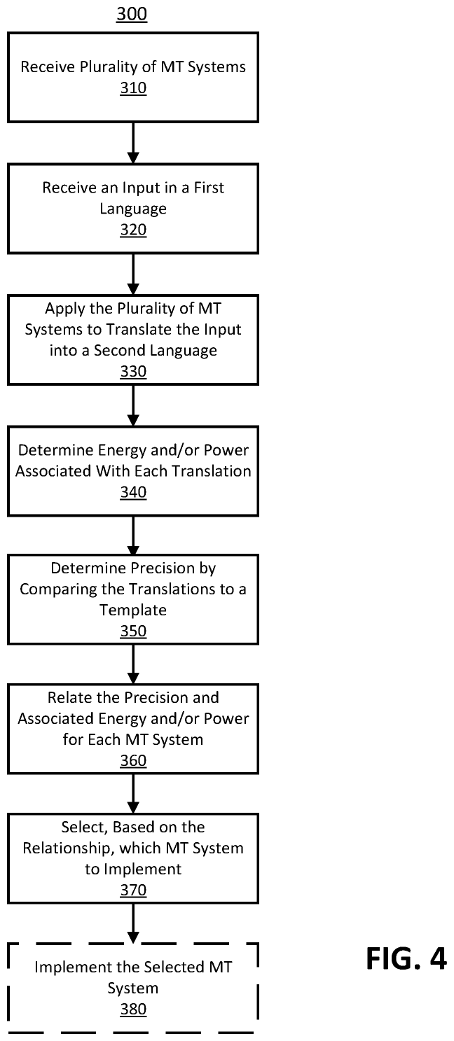

FIG. 4 illustrates a flowchart of an exemplary method 300, according to various embodiments of the specification. The method 300 may be implemented in various environments including, for example, on a computer. In some embodiments, the method 300 may be performed by the exemplary system 10. The operations of the method 300 presented below are intended to be illustrative. Depending on the implementation, the method 300 may include additional, fewer, or alternative steps performed in various orders or in parallel. The method 300 may be implemented in various computing systems or devices including one or more processors.

With respect to the method 300, at block 310, the method 300 may comprise receiving a plurality of MT systems. In some embodiments, the block 310 may be performed by the secondary computer 14 of the exemplary system 10. For example, the secondary computer 14 may receive the testing computer 11 as well as other computers to be tested by the secondary computer 14, at overlapping times or in sequence.

In some embodiments receiving an MT system (e.g., a computer that can run an MT model) may include connecting to the MT system with a wired and/or wireless connection. In some embodiments, receiving an MT system may include connecting the MT system to a power monitor. For example, receiving an MT system may comprise connecting the testing computer 11 to the power monitor 12. In some embodiments, an MT system may comprise software that is downloaded to be run on existing hardware—for example, the same hardware could perform a translation, determine a precision term for the translation, obtain power and/or energy information, and compute an overall score. For example, the testing computer 11 may perform a translation; the precision term for the translation may be determined either locally (e.g., on the testing computer 11 itself) or remotely (e.g., by sending the translation result to another computer for evaluation); the determined precision term may be sent to the secondary computer 14, which also reads the power and/or energy monitoring results from the power monitor 12; and then the secondary computer 14 may combine the received precision term and the read power and/or energy monitoring results to compute an overall score. In some embodiments, the same hardware may perform a translation using different sets of software. In such an embodiment, receiving an MT system may be performed each time the hardware is paired with the software.

The MT systems may be received sequentially or simultaneously. Each MT system may comprise hardware and/or software. In some embodiments, each of the two or more MT systems may comprise different hardware, software comprising algorithms written in different software languages, and/or different algorithms (or models). For example, in some embodiments, MT systems may comprise different CPUs and/or GPUs. As another example, in some embodiments, MT systems may comprise software with algorithms involving neural networks, and a neural network incorporated into a first MT system may have fewer hidden layers (or narrower layers) than a neural network incorporated into a second MT system.

At block 320, the method 300 may comprise receiving an input in a first language. In some embodiments, the block 320 may be performed by the testing computer 11 of the exemplary system 10. Receiving an input in a first language may comprise receiving content in English, German, French, Chinese, or some other language. Receiving an input in a first language may comprise receiving a document, such as a Word document, a text document, or a PDF document.

At block 330, the method 300 may comprise applying the plurality of MT systems to translate the input into a second language. If two or more MT systems are applied simultaneously to copies of an input, then it may be advantageous to have an equal number of components (e.g., ammeters) for independently measuring power characteristics (e.g., current) for each MT system. In some embodiments, each MT system may be connected to a dedicated power monitor (the power monitor 12 in FIG. 1) or a plurality of power monitors to quantify the error in their measurements. In some embodiments, multiple MT systems may be connected to a same power monitor. In some embodiments, each of the plurality of outputs may have different precision, power, and/or energy characteristics. Applying an MT system to translate an input may comprise generating a document (or other form of content representation) using that MT system.

At block 340, the method 300 may comprise determining energy and/or power associated with each translation. In some embodiments, the block 340 may be performed by the secondary computer 14 and/or power monitor 12 of the exemplary system 10. Determining energy and/or power associated with each translation may comprise, for each MT system, any one of the steps as described for block 230 of the method 200.

At block 350, the method 300 may comprise determining a precision by comparing translations to a template. In some embodiments, the block 350 may be performed by the secondary computer 14 of the exemplary system 10. In some embodiments, a template may be created or otherwise validated by a human. In some embodiments, a precision may be a term that comprises a BLEU score. In some embodiments, a precision may be a term that consists of a BLEU score. In some embodiments, determining a precision may comprise determining an error rate or F-score.

At block 360, the method 300 may comprise relating the precision and associated energy and/or power for each MT system. In some embodiments, the block 360 may be performed by the secondary computer 14 of the exemplary system 10. This step may comprise, for each MT system, performing any of the steps of determining the overall score of block 140 of the method 100, or block 270 of the method 200. Determining a precision for each MT system may comprise determining one precision term for each MT system, resulting in a plurality of precision terms.

At block 370, the method 300 may comprise selecting, based on the relationship, which of the plurality of MT systems to deploy. In some embodiments, the block 370 may be performed by the secondary computer 14 of the exemplary system 10. In some embodiments, selecting which MT system to deploy may comprise comparing overall scores attributable to two or more MT systems for a particular task, or over more than one task. For example, overall scores may be averaged over multiple translations, and the average scores of multiple MT systems may be compared. In some embodiments, selecting which MT system to deploy may comprise selecting the MT system that has the best relationship between precision and associated power and/or energy. In some embodiments, selecting which MT system to deploy may comprise selecting the MT system that has the largest overall score.

In some embodiments, selecting which MT system to deploy may comprise selecting an MT system that includes one or more features from two or more MT systems based on a comparison of three or more overall scores. For example, suppose that ten MT systems are tested, each having one of three hardware configurations, one of seven MT models/algorithms, and one of two software languages. This provides forty-two possible combinations and only ten MT systems. It may be determined, such as by the secondary computer 14, that—based on the results from the ten MT systems—a combination that was not specifically tested may actually be the best.

At block 380, the method 300 may comprise deploying the selected MT system. In some embodiments, the block 380 may be performed by the secondary computer 14 of the exemplary system 10. In some embodiments, deploying the selected MT system may be a step that is performed extraneous to the method 300. In some embodiments, deploying the selected MT system may comprise using the hardware and/or software associated with the MT system to perform a task after training. In some embodiments, deploying the selected MT system may comprise deploying the hardware and/or software associated with the selected MT system in a server farm, such as for performing machine translations in the cloud. In some embodiments, deploying the selected MT system may comprise an individual or a company choosing to use the MT system service provider (or cloud service provider) whose associated MT system had the best overall score.

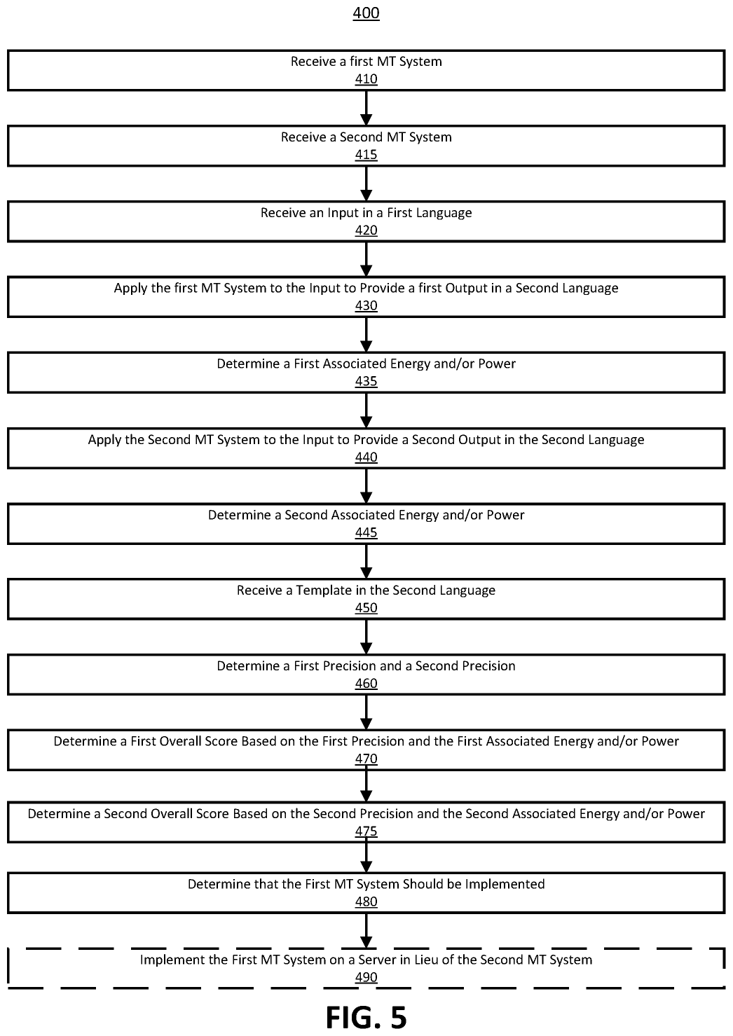

FIG. 5 illustrates a flowchart of an exemplary method 400, according to various embodiments of the specification. The method 400 may be implemented in various environments including, for example, on a computer. In some embodiments, the method 400 may be performed by the exemplary system 10. The operations of the method 400 presented below are intended to be illustrative. Depending on the implementation, the method 400 may include additional, fewer, or alternative steps performed in various orders or in parallel. The method 400 may be implemented in various computing systems or devices including one or more processors.

With respect to the method 400, at block 410, the method 400 may include receiving a first MT system. In some embodiments, the block 410 may be performed by the secondary computer 14 of the exemplary system 10. Receiving a first MT system may comprise performing the steps of receiving an MT system as in block 210 of the method 200.

At block 415, the method 400 may include receiving a second MT system. In some embodiments, the block 415 may be performed by the secondary computer 14 of the exemplary system 10. Receiving a second MT system may comprise performing the steps of receiving an MT system as in block 210 of the method 200, similar to the receiving the first MT system of block 410 of the method 400. However, it is to be noted that the first MT system and the second MT system are not the same. There may be a difference in at least one of the model, the training or inference algorithms, the hardware, or the software language that the algorithm is written in. For example, the model of the first MT system may comprise fewer hidden layers than the second MT system.

At block 420, the method 400 may comprise receiving an input in a first language. In some embodiments, the block 420 may be performed by the testing computer 11 of the exemplary system 10. Receiving an input in a first language may comprise receiving content in English, German, French, Chinese, or some other language. Receiving an input in a first language may comprise receiving a document, such as a Word document, a text document, or a PDF document. Receiving an input in a first language may also be performed by the secondary computer 14 of the exemplary system 10 such that the secondary computer 14 can forward the input to one or more testing computers (e.g., MT systems).

At block 430, the method 400 may include applying the first MT system to the input to provide a first output in a second language. This step may comprise, for the first MT system, performing the steps of block 230 of the method 200.

At block 435, the method 400 may include determining a first associated energy and/or power. In some embodiments, the block 435 may be performed by the secondary computer 14 and/or power monitor 12 of the exemplary system 10. This step may comprise determining a power term and/or an energy term associated with generating the first output. The associated energy and/or power terms may be referred to as characteristics of the system in generating an output. This step may involve, for the first MT system, performing the steps of block 240 of the method 200.

At block 440, the method 400 may include applying the second MT system to the input to provide a second output in a second language. This step may involve, for the second MT system, performing the steps of block 230 of the method 200.

At block 445, the method 400 may include determining a second associated energy and/or power. In some embodiments, the block 410 may be performed by the secondary computer 14 and/or power monitor 12 of the exemplary system 10. This step may comprise determining a power term and/or an energy term associated with generating the second output. This step may involve, for the second MT system, performing the steps of block 240 of the method 200.

At block 450, the method 400 may comprise receiving a template in the second language. In some embodiments, the block 450 may be performed by the secondary computer 14 of the exemplary system 10. A template in a second language may be an existing translation that is deemed to be accurate for purposes of comparison with an output. A template may comprise content that has been validated by a human, such as by being drafted by a human or by being reviewed by a human. In some embodiments, a template may be created by one or more human translators. For example, a template may comprise an English version of the input, and the input may have been a German document.

At block 460, the method 400 may include determining a first precision term and a second precision term. In some embodiments, the block 460 may be performed by the secondary computer 14 of the exemplary system 10. Determining a first precision term may comprise, for the first MT system, performing the steps of block 260 of the method 200. Determining a second precision term may comprise, for the second MT system, the same steps as block 260 of the method 200. Determining a first precision term and a second precision term may comprise determining a BLEU score for the first MT system and the second MT system based on the first output and the second output.

At block 470, the method 400 may include determining a first overall score based on the first precision and the first associated energy and/or power. In some embodiments, the block 470 may be performed by the secondary computer 14 of the exemplary system 10. This step may comprise, for the first MT system, performing the steps of block 270 of the method 200.

At block 475, the method 400 may include determining a second overall score based on the second precision and the second associated energy and/or power. In some embodiments, the block 475 may be performed by the secondary computer 14 of the exemplary system 10. This step may comprise, for the second MT system, performing the steps of block 270 of the method 200.

At block 480, the method 400 may include determining that the first MT system should be deployed. In some embodiments, the block 480 may be performed by the secondary computer 14 of the exemplary system 10. This may comprise performing the steps of block 370 of the method 300.

At block 490, the method 400 may include deploying the first MT system in lieu of the second MT system. In some embodiments, the block 490 may be performed by the secondary computer 14 of the exemplary system 10. In some embodiments, this step may comprise performing the steps of block 380 of the method 300. In some embodiments, deploying the first MT system may comprise uploading an algorithm or model associated with the first MT system onto one or more computers (such as onto one or more smartphones or other devices comprising one or more processors) and/or onto a server. In some embodiments, deploying the first MT system on a server may comprise accepting an offer from a server company associated with the first MT system, and rejecting the offer from a server company associated with the second MT system.

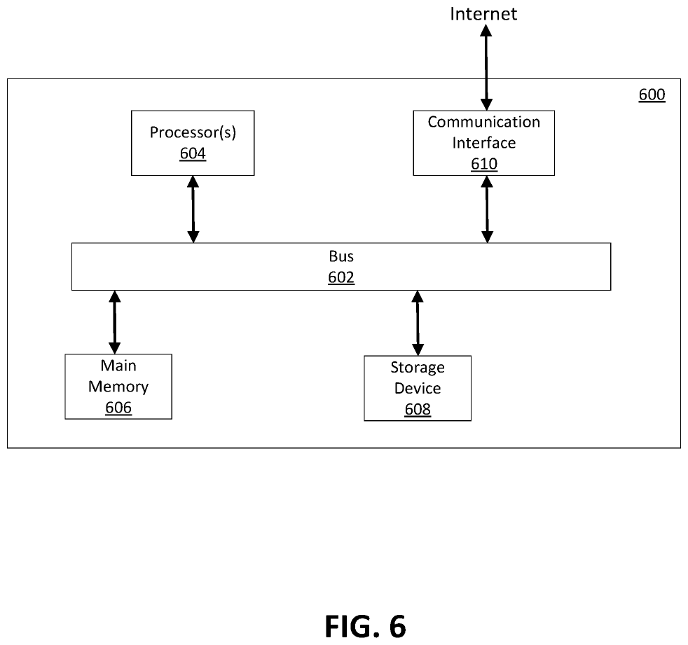

FIG. 6 is a block diagram that illustrates a computer system 600 upon which any of the embodiments described herein may be implemented. In some embodiments, the computer system 600 may be the one or more components of the exemplary system 10, such as the secondary computer 14 and/or testing computer 11. The computer system 600 includes a bus 602 or other communication mechanism for communicating information, one or more hardware processors 604 coupled with bus 602 for processing information. Hardware processor(s) 604 may be, for example, one or more general purpose microprocessors.

The computer system 600 also includes a main memory 606, such as a random-access memory (RAM), cache and/or other dynamic storage devices, coupled to bus 602 for storing information and instructions to be executed by processor(s) 604. Main memory 606 also may be used for storing temporary variables or other intermediate information during execution of instructions to be executed by processor(s) 604. Such instructions, when stored in storage media accessible to processor(s) 604, render computer system 600 into a special-purpose machine that is customized to perform the operations specified in the instructions. Main memory 606 may include non-volatile media and/or volatile media. Non-volatile media may include, for example, optical or magnetic disks. Volatile media may include dynamic memory. Common forms of media may include, for example, a floppy disk, a flexible disk, hard disk, solid state drive, magnetic tape, or any other magnetic data storage medium, a CD-ROM, any other optical data storage medium, any physical medium with patterns of holes, a RAM, a DRAM, a PROM, and EPROM, a FLASH-EPROM, NVRAM, any other memory chip or cartridge, and networked versions of the same.

The computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor(s) 604 executing one or more sequences of one or more instructions contained in main memory 606. Such instructions may be read into main memory 606 from another storage medium, such as storage device 608. Execution of the sequences of instructions contained in main memory 606 causes processor(s) 604 to perform the process steps described herein.

For example, the process/method shown in FIGS. 2-5 and described in connection with this figure may be implemented by computer program instructions stored in main memory 606. When these instructions are executed by processor(s) 604, they may perform the steps of the method 400 as shown in FIG. 5 and described above. In alternative embodiments, hard-wired circuitry may be used in place of or in combination with software instructions.

The computer system 600 also includes a communication interface 610 coupled to bus 602. Communication interface 610 provides a two-way data communication coupling to one or more network links that are connected to one or more networks. As another example, communication interface 610 may be a local area network (LAN) card to provide a data communication connection to a compatible LAN (or WAN component to communicate with a WAN). Wireless links may also be implemented.

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Certain embodiments are described herein as including logic or a number of components. Components may constitute either software components (e.g., code embodied on a machine-readable medium) or hardware components (e.g., a tangible unit capable of performing certain operations which may be configured or arranged in a certain physical manner).

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

What is claimed is:

1. A method comprising:
obtaining a machine-learning output generated by a computer system running a trained machine-learning model;
obtaining characteristics associated with the generation of the output, the characteristics comprising at least one of an energy term or a power term;
determining a precision term for the computer system based on a comparison of the output with a reference, the precision term indicating a similarity between the output and the reference; and
determining an overall score of the computer system based on the precision term and the characteristics.

2. The method of claim 1, wherein the machine-learning output comprises a machine translation.

3. The method of claim 2, wherein the precision term comprises a BLEU score.

4. The method of claim 1, wherein the trained machine-learning model comprises a natural-language-processing model.

5. The method of claim 1, wherein the characteristics comprise both an energy term and a power term.

6. The method of claim 1, wherein:
the precision term is a BLEU score;
the energy term is a energy efficiency that is based on a measured energy consumption and the BLEU score; and
the power term is a power efficiency that is based on a measured power consumption and the BLEU score.

7. The method of claim 1, wherein:
the computer system comprises a CPU, a GPU, a cooling system, a toolkit, and the trained machine-learning model is written in a software language; and
the method further comprises:
changing at least one of the CPU, the GPU, the cooling system, the toolkit, or the software language, and
repeating the steps of obtaining the machine-learning output, obtaining the characteristics, determining the precision term, and determining the overall score.

8. The method of claim 1, wherein:
the trained machine-learning model comprises a plurality of parameters and/or hyperparameters; and
the method further comprises:
iteratively changing the plurality of parameters and/or hyperparameters in the model,
repeating, for each iteration, the steps of obtaining the machine-learning output, obtaining the characteristics, determining the precision, and determining the overall score, and
determining, based on a comparison of the determined overall scores, an optimal parameter and/or hyperparameter settings for the model.

9. The method of claim 1, wherein determining the overall score comprises:
scaling the precision term based on a baseline precision term;
if the characteristics comprise an energy term, scaling the energy term based on a baseline energy term; and
if the characteristics comprise a power term, scaling the power term based on a baseline power term.

10. The method of claim 9, wherein:
the precision term comprises a BLEU score;
the energy term comprises the inverse of the energy consumed by the system to generate the machine-learning output; and
the terms are each scaled by a different factor.

11. The method of claim 1, wherein determining the overall score further comprises applying a step function.

12. A system comprising:
one or more processors; and
a memory storing instructions that, when executed by the one or more processors, cause the system to perform:
obtaining a machine-learning output generated by a computer system running a trained machine-learning model;
obtaining characteristics associated with the generation of the output, the characteristics comprising at least one of an energy term or a power term;
determining a precision term for the trained machine-learning model based on a comparison of the output with a template; and
determining an overall score of the computer system running the trained machine-learning model based on the precision term and the characteristics.

13. The system of claim 12, wherein:
the machine-learning output comprises a machine translation; and
the determining the precision term comprises computing a BLEU score.

14. The system of claim 12, wherein the computer system comprises a natural-language-processing algorithm.

15. The system of claim 12, wherein:
the energy term is a decoding energy efficiency that is based on a measured energy consumption;
the power term is a decoding power efficiency that is based on a measured power consumption; and
the precision term is a BLEU score.

16. The system of claim 12, wherein the determining the overall score comprises:
scaling the precision term by a first factor;
if the characteristics comprise an energy term, scaling the energy term by a second factor;
if the characteristics comprise a power term, scaling the power term by a third factor; and
taking the square root of the sum of squares of the scaled terms.

17. The system of claim 12, wherein the instructions further cause the one or more processors to perform:
determining that the computer system running the trained machine-learning model is inferior to another computer system; and
displaying on a monitor, based on the determined inferiority, a notification indicating that the computer system running the trained machine-learning model should not be deployed.

18. A method of determining which machine translation (MT) system to deploy, the method comprising:
obtaining a first MT output, the first MT output having been generated by a first MT system;
obtaining a second MT output, the second MT output having been generated by a second MT system;
obtaining an MT reference, comprising a reference translation to be compared against;
obtaining first characteristics associated with the generation of the first MT output, the first characteristics comprising at least one of energy or power;
obtaining second characteristics associated with the generation of the second MT output, the second characteristics comprising at least one of energy or power;
determining a precision of the first MT system based on a comparison of the first MT output and the MT reference;
determining a precision of the second MT system based on a comparison of the second MT output and the MT reference;
determining an overall score for the first MT system based on the precision of the first MT system and the first characteristics;
determining an overall score for the second MT system based on the precision of the second MT system and the second characteristics;
comparing the overall score for the first MT system and the overall score for the second MT system; and
determining, based on the comparison of the overall scores, that the first MT system be deployed.

19. The method of claim 18, further comprising deploying the first MT system, in lieu of the second MT system.

20. The method of claim 18, wherein:
the energy is a decoding energy efficiency that is based on a measured energy consumption;
the power is a decoding power efficiency that is based on a measured power consumption; and
the precision comprises a BLEU score.
